(19) United States
(12) Patent Application Publication
(10) Pub. No.: US 2014/0071974 A1
(43) Pub. Date: Mar. 13, 2014

(54) INFORMATION PROCESSING APPARATUS, INFORMATION PROCESSING METHOD AND COMPUTER PROGRAM

(71) Applicants: Yasuhiro Watari, Tokyo (JP); Fumitaka Otsuka, Tokyo (JP); Hiroaki Hashiguchi, Tokyo (JP)

(72) Inventors: Yasuhiro Watari, Tokyo (JP); Fumitaka Otsuka, Tokyo (JP); Hiroaki Hashiguchi, Tokyo (JP)

(73) Assignee: SONY CORPORATION, Tokyo (JP)

(21) Appl. No.: 14/114,864

(22) PCT Filed: Jul. 2, 2012
(86) PCT No.: PCT/JP2012/004272

§ 371 Date: Oct. 30, 2013

(30) Foreign Application Priority Data
Jul. 19, 2011 (JP) 2011-157971

(51) Int. Cl. H04W 12/06; H04W 88/04

(52) U.S. Cl. CPC H04W 12/06; H04W 88/04
USPC 370/338

(57) ABSTRACT

An apparatus includes an input unit, an information generating unit, and a communication unit. The input unit is configured to receive an input gesture from a user. The information generating unit is configured to generate first information based on the input gesture. The communication unit configured to transmit the first information to another apparatus, receive second information from the another apparatus, and operate the apparatus as an access point of a network or to connect the apparatus to an access point created by the other apparatus based on the first information and the second information.

### CROSS-REFERENCE TO RELATED APPLICATIONS

The present application is based upon and claims the benefit of priority under 35 U.S.C. 119 of Japanese Priority Patent Application JP 2011-157971 filed in the Japanese Patent Office on Jul. 19, 2011, the entire contents of which are hereby incorporated by reference.

### TECHNICAL FIELD

The present disclosure relates to an information processing apparatus configuring a communication network, an information processing method, a computer program encoded on a non-transitory computer readable medium, and a system including multiple information processing apparatuses.

### BACKGROUND ART

In small-sized information processing terminals, such as portable telephones, portable information terminals, and tablet terminals, data can be held in a terminal and an operation of data or execution of an application can be performed at any place. Further, an information processing terminal can make a connection with a network and perform data communication with another terminal connected to the network. For example, image data, address information, or the like can be easily transmitted or received through data communication between terminals.

Data communication between terminals located at a short distance can be performed using a wireless communication technique such as infrared-ray (IR) communication or Bluetooth (registered trademark). In order to establish data communication between terminals, a connection authentication process to input authentication information such as a password or an authentication code needs to be performed. At this time, typically, when a user does not input authentication information or prior setting to execute a connection authentication process is not made, the workload of the user is large. In this regard, for example, Patent Document 1 discloses a method of explicitly designating an information processing apparatus that performs data communication and simply performing connection authentication for data communication between devices without needing to perform setting for connection preparation. In Patent Document 1, a communication section is authenticated when gestures input through a plurality of devices are compared and then gestures regarded as having relevance are input at the same time.

### CITATION LIST

### Patent Literature

### PTL 1: Japanese Patent Application Laid-Open No. 2010-97340

### SUMMARY

### Technical Problem

However, in Patent Document 1, in order for a new device to additionally connect to an already formed network, the same operation needs to be performed once again on a device to be additionally connected, and an operation and authentication need to be performed at the same timing. Furthermore, for the sake of authentication, the same operation needs to be performed in a state in which devices are close to each other. In addition, authentication is not performed when an already established network is not present.

In this regard, it is desirable to easily form a network for performing data communication between information processing terminals and make it easy to additionally connect an information processing terminal to a network or to cause an information processing terminal connected to a network to leave the network.

### Solution to Problem

Accordingly, the present disclosure broadly comprises an apparatus, a method, a non-transitory computer readable medium encoded with a program which causes the processor to perform the method, and a system including multiple apparatuses. In one embodiment, the apparatus includes an input unit, an information generating unit, and a communication unit. The input unit is configured to receive an input gesture from a user. The information generating unit is configured to generate first information based on the input gesture. The communication unit configured to transmit the first information to another apparatus, receive second information from the another apparatus, and operate the apparatus as an access point of a network or to connect the apparatus to an access point created by the other apparatus based on the first information and the second information.

According to the present disclosure, authentication information is generated based on input gesture, and a parent terminal functioning as an access point and a child terminal connected thereto are automatically decided based on a communication relation with an information processing apparatus that has generated the same authentication information. Thus, a network can be easily formed by a simple input.

Further, according to the present disclosure, there is provided an information processing method which includes receiving an input gesture from a user, generating first information based on the input gesture, transmitting the first information to another apparatus, receiving second information from the another apparatus, and operating the apparatus as an access point of a network or to connect the apparatus to an access point created by the other apparatus based on the first information and the second information.

Further, according to the present disclosure, there is provided a non-transitory computer readable medium encoded with a computer program causing a computer to perform a method including receiving an input gesture from a user, generating first information based on the input gesture, transmitting the first information to another apparatus, receiving second information from the another apparatus, and operating the apparatus as an access point of a network or to connect the apparatus to an access point created by the other apparatus based on the first information and the second information.

### Advantageous Effects of Invention

As described above, according to the present disclosure, a network for performing data communication can be easily formed between information processing terminals.

### BRIEF DESCRIPTION OF DRAWINGS

FIG. 1 is an explanatory view to describe a network formed by information processing terminals according to an embodiment of the present disclosure.

FIG. 2 is a block diagram illustrating a functional configuration of an information processing terminal according to the same embodiment.

FIG. 3 is an explanatory view illustrating an example of information stored in an authentication information storage unit.

FIG. 4 is a flowchart illustrating a new network forming process by an information processing terminal according to the present embodiment.

FIG. 5 is an explanatory view illustrating an example of a shape recognized from an input gesture.

FIG. 6 is an explanatory view illustrating an example of a character string which an information generating unit generates based on a recognized shape.

FIG. 7 is an explanatory view to describe a process in which an information generating unit generates authentication information based on a recognized shape.

FIG. 8 is a flowchart illustrating a process in which a parent terminal leaves a network according to the same embodiment.

FIG. 9 is a block diagram illustrating a hardware configuration example of an information processing terminal according to the same embodiment.

### DESCRIPTION OF EMBODIMENTS

Hereinafter, an exemplary embodiment of the present disclosure will be described in detail with reference to the accompanying drawings. In this disclosure and drawings, components having substantially the same functional configurations are denoted by the same reference numerals, and the redundant description thereof will not be repeated.

A description will be made in the following order:

1. Network Formed by Information Processing Terminal

2. Functional Configuration of Information Processing Terminal

3. New Network Forming Process

4. Process of Making Additional Connection to Network

5. Process in Which Parent Terminal Leaves Network

6. Hardware Configuration Example

<1. Network Formed by Information Processing Terminal>

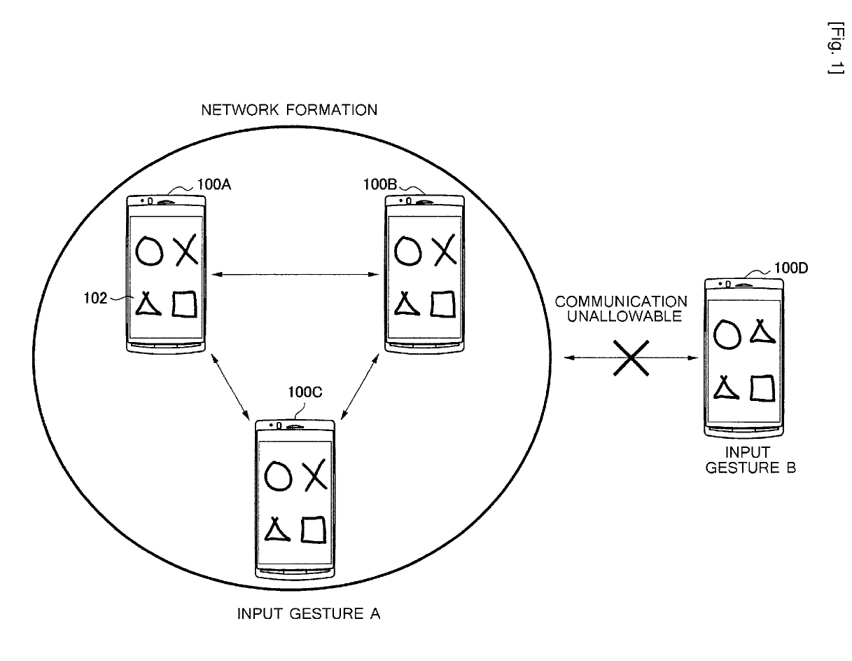

First, a network formed by information processing terminals according to an embodiment of the present disclosure will be described with reference to FIG. 1. FIG. 1 is an explanatory view to describe a network formed by information processing terminals 100A to 100D according to the present embodiment.

The information processing terminals 100A to 100D illustrated in FIG. 1 are, for example, portable telephones, digital cameras, portable tablet terminals, or the like. Each of the information processing terminals 100A to 100D includes a touch panel 102 used to input a gesture as authentication information and a communication unit that performs data communication between terminals.

When the user inputs a gesture used as authentication information on each of touch panels 102, each of the information processing terminals 100A to 100D generates a character string corresponding to the input gesture. Then, each of the information processing terminals 100A to 100D generates a service set identifier (SSID) and a password of an access point (AP) of a network. A network is formed among the information processing terminals 100A to 100D which generated a same SSID and password as one another.

For example, it is assumed that in the information processing terminals 100A to 100C, diagrams of “O”, “′”, “r”, and “&pound;” are input on an upper left portion, an upper right portion, a lower left portion, and a lower right portion of the touch panel 102, respectively, by a gesture as illustrated in FIG. 1. This input gesture is referred to as a “gesture A”. Meanwhile, in the information processing terminal 100D, diagrams of “O”, “r”, “r”, and “&pound;” are input on an upper left portion, an upper right portion, a lower left portion, and a lower right portion of the touch panel 102, respectively, by a gesture. This input gesture is referred to as a “gesture B”.

In the information processing terminals 100A to 100C to which the gesture A is input, since the same character string is generated, the same SSID and password are generated. Thus, in the information processing terminals 100A to 100C to which the gesture A is input, connection authentication based on the SSID and the password is successfully performed, and so a network is formed. However, in the information processing terminal 100D to which the gesture B is input, a character string different from in the case of the gesture A is generated, and so an SSID and a password different from in the case of the gesture A are generated. For this reason, the SSID and the password generated by the information processing terminal 100D do not match an SSID and a password of an access point of a network formed by the information processing terminals 100A to 100C, and so connection authentication fails for terminal 100D. Thus, it is difficult for the information processing terminal 100D to perform data communication with the information processing terminals 100A to 100C.

As described above, the information processing terminal 100 according to the present embodiment can receive an input of an intuitive and simple operation such as a gesture and automatically generate an SSID and a password, and a network can be formed between terminals which have succeeded in connection authentication. By inputting an SSID and a password of an access point of a formed network, a new information processing terminal 100 can be easily additionally connected to the network. Further, the information processing terminal 100 according to the present embodiment can transfer an access point to another terminal connected to the network even when the information processing terminal 100 is a parent terminal functioning as the access point of the network. Thus, the information processing terminal 100 can leave the network without releasing a connection relation of the formed network.

Next, a configuration of the information processing terminal 100 according to the present embodiment and network formation by a plurality of information processing terminals 100 will be described in detail.

<2. Functional Configuration of Information Processing Terminal>

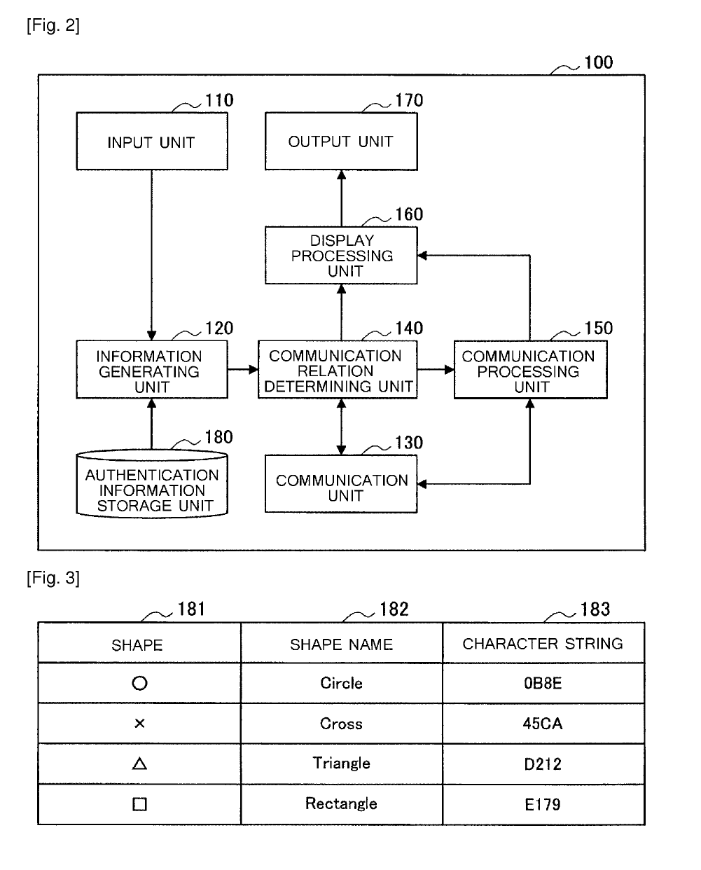

First, a functional configuration of the information processing terminal 100 according to the present embodiment will be described with reference to FIGS. 2 and 3. FIG. 2 is a block diagram illustrating a functional configuration of the information processing terminal 100 according to the present embodiment. FIG. 3 is an explanatory view illustrating an example of information stored in an authentication information storage unit 180. FIG. 2 illustrates functional units that perform a network forming process for the information processing terminal 100, and obviously the information processing terminal 100 can further include any other functional unit.

The information processing terminal 100 according to the present embodiment includes an input unit 110, an information generating unit 120, a communication unit 130, a communication relation determining unit 140, a communication processing unit 150, a display processing unit 160, an output unit 170, and an authentication information storage unit 180 as illustrated in FIG. 2.

The input unit 110 is a functional unit that allows the user to input information to the information processing terminal 100 and may be configured with, for example, an electrostatic type touch sensor or a pressure-sensitive type touch sensor. The information processing terminal 100 may include a hardware button or the like as the input unit 110. In the present embodiment, for example, the input unit 110 is used for the user to input a gesture as authentication information in order to form a network with another information processing terminal 100 or used to notify another information processing terminal 100 of an intention to cause the information processing terminal 100 to leave the network. Input information input from the input unit 110 is output to the information generating unit 120.

The information generating unit 120 generates authentication information necessary to form a network based on the input information input from the input unit 110. The information generating unit 120 recognizes the gesture input from the input unit 110, and generates a character string corresponding to the recognized gesture with reference to the authentication information storage unit 180 which will be described later. The information generating unit 120 further generates an SSID and a password necessary to set an access point as authentication information used to form a network, based on the generated character string. The generated authentication information is output to the communication relation determining unit 140. Upon receiving the intention causing the information processing terminal 100 to leave the network from the input unit 110, the information generating unit 120 outputs an instruction for starting a leaving process to the communication relation determining unit 140.

The communication unit 130 is an interface used to perform data communication with another information processing terminal 100. The communication unit 130 transmits information input from the communication relation determining unit 140 to another information processing terminal 100 or receives information from another information processing terminal 100.

The communication relation determining unit 140 determines a formation state of a network formed based on authentication information input by a gesture. The communication relation determining unit 140 determines whether or not an access point to which an SSID generated by the information generating unit 120 is set is already present. In other words, the communication relation determining unit 140 determines whether or not a parent terminal functioning as an access point to which a corresponding SSID and a password are set is present. As a result, the communication relation determining unit 140 determines a communication relation with another information processing terminal 100. That is, the communication relation determining unit 140 determines whether to form a new network or to make an additional connection to an existing network. Further, when the own information processing terminal 100 is the parent terminal and desires to leave the network, the communication relation determining unit 140 performs a process of specifying the information processing terminal 100 to which an access point is to be transferred from among other information processing terminals 100 connected to the same network.

In order to notify the user of the network formation state, the communication relation determining unit 140 may output information related to data transmitted/received to/from the information processing terminal 100 through the communication unit 130 to the display processing unit 160. The details of the process by the communication relation determining unit 140 will be described later.

The communication processing unit 150 performs a process of forming a network or a process leaving a connected network based on the communication relation with another information processing terminal 100, which is transmitted from the communication relation determining unit 140. When the communication relation determining unit 140 determines that a new network is to be formed, the communication processing unit 150 performs connection authentication with another information processing terminal 100 to form a network. Further, when the own information processing terminal 100 is the parent terminal and desires to leave a network, the communication processing unit 150 transfers an access point to the information processing terminal 100 specified by the communication relation determining unit 140. At this time, the communication processing unit 150 performs data communication with another information processing terminal 100 through the communication unit 130.

In order to notify the user of a communication state with another information processing terminal 100, the communication processing unit 150 may output information related to data transmitted/received to/from the information processing terminal 100 through the communication unit 130 to the display processing unit 160. The details of the process by the communication processing unit 150 will be described later.

The display processing unit 160 performs a display process for notifying the user of the network formation state input from the communication relation determining unit 140 or the communication state with another information processing terminal 100 input from the communication processing unit 150. For example, the display processing unit 160 performs the display process for outputting a message notifying of the network formation state or the communication state with another information processing terminal 100 to the output unit 170.

The output unit 170 is an output device that outputs information and may include, for example, a display device such as a liquid crystal display (LCD) device or an organic EL display device. Information which has been subjected to the display process by the display processing unit 160 is displayed on the output unit 170. The output unit 170 may be an audio output device that outputs a sound such as a speaker. In this case, the information processing terminal 100 may further include an audio processing unit (not illustrated) that notifies the user of the network formation state input from the communication relation determining unit 140 or the communication state with another information processing terminal 100 input from the communication processing unit 150 through a sound.

The authentication information storage unit 180 is a storage unit that stores a gesture input from the input unit 110 in association with a character string used to generate authentication information. FIG. 3 illustrates a configuration example of the authentication information storage unit 180. The authentication information storage unit 180 illustrated in FIG. 3 stores a shape 181 represented by a gesture input from the input unit 110, a shape name 182, and a character string 183 corresponding to the shape. The information generating unit 120 may acquire a character string corresponding to an input gesture with reference to the authentication information storage unit 180 and then generate authentication information.

The functional configuration of the information processing terminal 100 according to the present embodiment has been described so far. The information processing terminal 100 generates authentication information necessary to form a network between terminals based on a gesture. Then, based on the generated authentication information, a parent terminal which functions as an access point of a network and a child terminal which accesses the parent terminal are decided between the information processing terminals 100, and then a connection authentication process is performed to thereby form a network. Further, when the parent terminal desires to leave a network, performed is the process of specifying the information processing terminal 100 which can function as the parent terminal from among other information processing terminals 100 (that is, child terminals) connected to the corresponding network and then transferring the function of the parent terminal.

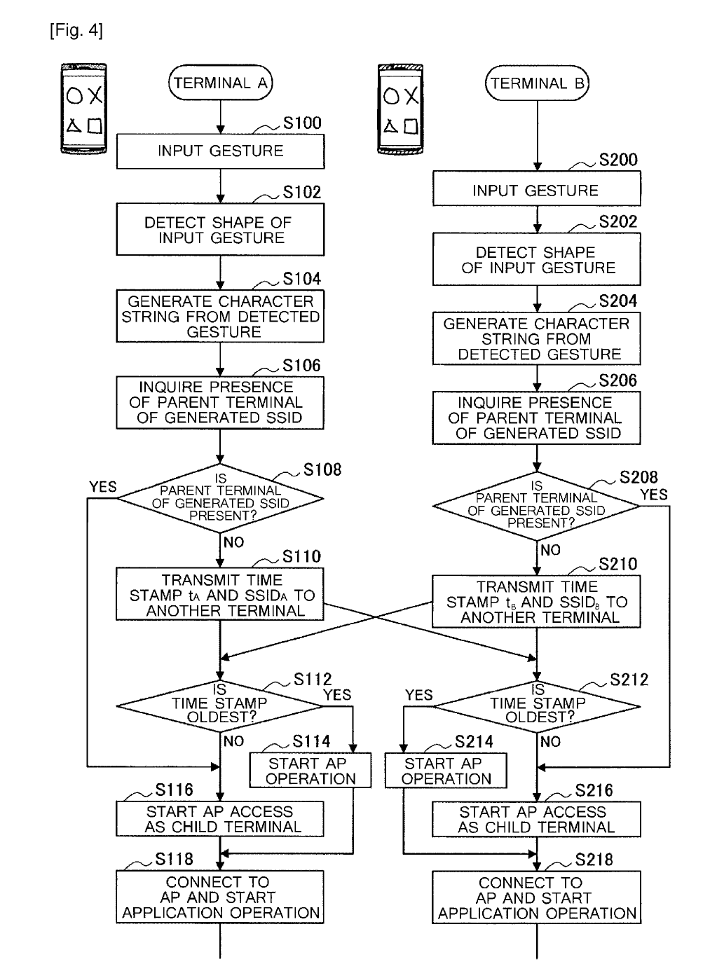

As described above, according to the information processing terminal 100 of the present embodiment, a network can be simply formed between the information processing terminals 100 using the authentication information based on the gesture. Next, a new network forming process, a process of making an additional connection to a network, and a process in which a parent terminal leaves a network, which are performed by the information processing terminal 100 according to the present embodiment, will be described with reference to FIGS. 4 to 8.

<3. New Network Forming Process>

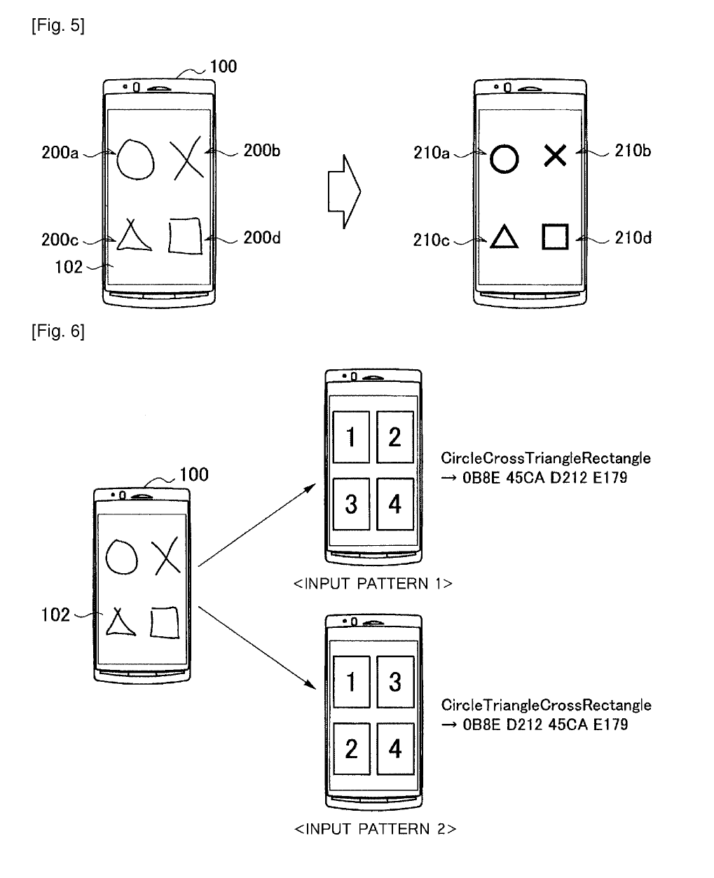

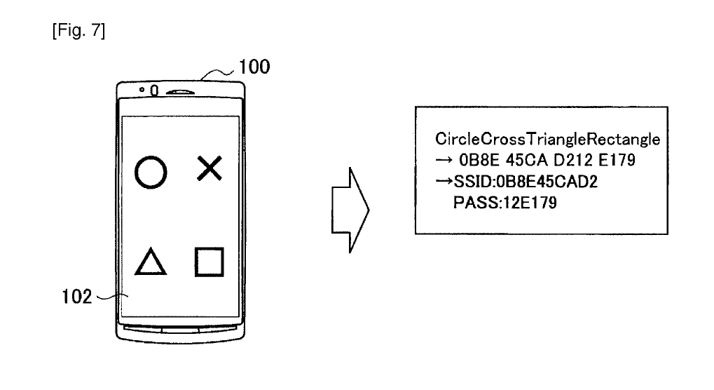

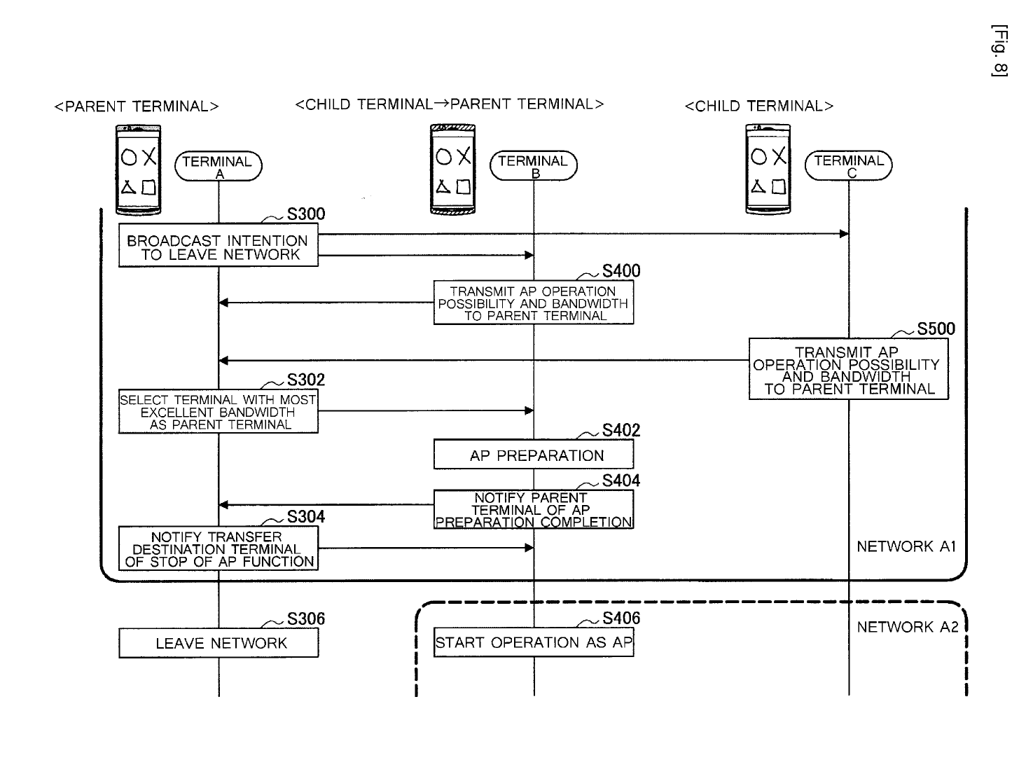

First, the new network forming process by the information processing terminal 100 according to the present embodiment will be described with reference to FIGS. 4 to 7. FIG. 4 is a flowchart illustrating the new network forming process by the information processing terminal 100 according to the present embodiment. FIG. 5 is an explanatory view illustrating an example of a shape recognized from an input gesture. FIG. 6 is an explanatory view illustrating an example of a character string which an information generating unit 120 generates based on a recognized shape. FIG. 7 is an explanatory view to describe a process in which the information generating unit 120 generates authentication information based on a recognized shape.

FIG. 4 illustrates an example in which a network is formed between two information processing terminals 100 (a terminal A and a terminal B) for the sake of simplicity. The present technology is not limited to this example, and a network may be formed among three or more information processing terminals 100. In this case, the same process as in FIG. 4 may be performed.

First, in the terminals A and B that desire to perform data communication between the information processing terminals 100, gestures which become authentication information are input (S100 and S200). The gestures are input through the input unit 110 of each terminal using an operation body such as a finger or a stylus pen. The input unit 110 acquires locus information of the operation body input on a coordinates input surface of the input unit 110, and outputs the locus information to the information generating unit 120.

Then, when the locus information of the operation body is acquired from the input unit 110, the information generating unit 120 detects the shape of the gesture input from the locus information of the operation body (S102 and S202). For example, it is assumed that in the information processing terminals 100 (the terminals A and B), diagrams recognizable as “O” (an input gesture 200a), “′” (an input gesture 200b), “r” (an input gesture 200c), and “&pound;” (an input gesture 200d) have been input on an upper left portion, an upper right portion, a lower left portion, and a lower right portion, respectively, by a gesture as illustrated in FIG. 5. The information generating unit 120 searches for a shape having high similarity using a dictionary installed in each terminal as a bundle by the same program installed in each terminal. The shape having high similarity may be specified by any other method, and a dictionary may not be held in a terminal.

When the input gestures 200a to 200d are recognized, the information generating unit 120 specifies a shape having highest similarity among shapes stored in the authentication information storage unit 180, and further acquires an input order of the input gestures 200a to 200d. Then, the information generating unit 120 generates character strings based on the detected gestures and the input order, that is, based on the shapes of the input gestures and the input order (S104 and S204). The information generating unit 120 acquires predetermined associated character strings based on the specified shapes, for example, as illustrated in FIG. 3. Then, the information generating unit 120 connects the acquired character strings to one another based on the input order of the input gestures.

For example, it is assumed that “O” (input gesture 200a), “′” (input gesture 200b), “r” (input gesture 200c), and “&pound;” (input gesture 200d) have been input on an upper left portion, an upper right portion, a lower left portion, and a lower right portion, respectively, as illustrated in FIG. 6. At this time, when the input gestures 200a to 200d are input in the order of the upper left, the upper right, the lower left, and the lower right like an input pattern 1, the information generating unit 120 connects the character strings acquired in this input order. Further, when the input gestures 200a to 200d are input in the order of the upper left, the lower left, the upper right, and the lower right like an input pattern 2, the information generating unit 120 connects the character strings acquired in this input order. Thus, when an input order of diagrams is different, a generated character string is also different. This can increase security of authentication information, and a variation of authentication information can increase.

Thereafter, each of the terminals A and B generates an SSID and a password used as authentication information based on the generated character string. For example, two character strings obtained by dividing the character string generated based on the input gesturer at a predetermined position may be used as the SSID and the password as illustrated in FIG. 7. The position for dividing the character string may be set in advance. In FIG. 7, a generated character string “0B8E45CAD212E179” is divided at a tenth character, and “OB8E45CAD2” and “12E179” are used as an SSID and a password, respectively. An SSID and a password may be generated by a method other than a method illustrated in FIG. 7. For example, “OB8E42E179” connecting five characters at the front of the character string with five characters at the rear there of may be used as an SSID, and six characters “5CAD21” between the five characters at the front and the five characters at the rear may be used as a password.

Next, each of the terminals A and B inquires about whether or not a corresponding SSID and a parent terminal functioning as an access point are already present on the generated SSID (S106 and S206). In steps S106 and S206, the communication relation determining unit 140 transmits the generated SSID through the communication unit 130 by a beacon. Then, the communication relation determining unit 140 determines the presence of the parent terminal based on whether or not a reply has been received from a terminal (parent terminal) which is an access point to which the transmitted SSID is set within a predetermined time in response to the corresponding transmission (S108 and S208).

The terminals A and B that have received the reply from the parent terminal in steps S108 and S208 function as the child terminals connected to the network formed by the parent terminal and so execute processes of steps S116 and S216 and subsequent processes. Meanwhile, when the reply from the parent terminal has not been received in steps S108 and S208, the terminals A and B form a new network and so decide a parent terminal which functions as an access point. For this reason, the terminals A and B broadcast time stamps (t_{A} and t_{B}) and SSIDs (SSID_{A} and SSID_{B}) to another terminal by a beacon (S110 and S210). The time stamps t_{A} and t_{B} refer to timings at which the processes of steps S110 and S210 are executed, respectively.

In the present embodiment, a terminal that has executed the processes of steps S110 and S210 at the earliest time is decided as a parent terminal functioning as an access point. In this regard, the communication relation determining unit 140 compares its own time stamp with a time stamp which is the same in the received SSID and determines whether or not its own time stamp is oldest (S112 and S212). For example, the terminal A determines whether or not the time stamp t_{A} is older than the time stamp t_{B} of the terminal B, and the terminal B determines whether or not the time stamp t_{B} is older than the time stamp t_{A} of the terminal A.

Then, when it is determined in steps S112 and S212 that its own time stamp is oldest, the communication relation determining unit 140 causes the communication processing unit 150 to execute the process of causing its own terminal to function as a parent terminal of an access point (S114 and S214). Meanwhile, when it is determined in steps S112 and S212 that there is a terminal having a time stamp older than its own time stamp, the communication relation determining unit 140 causes the communication processing unit 150 to execute the process of causing its own terminal to function as a child terminal connected to an access point (S116 and S216). Accordingly, a parent terminal that functions as an access point of a network and a child terminal connected to the access point can be decided.

Since then, the terminal A or B which functions as the child terminal performs authentication for a connection to the access point using the authentication information. When the authentication is successfully performed, application communication can be performed (S118 and S218). At this time, the communication processing unit 150 performs a process of displaying the success of a connection on the display processing unit 160 and causes the fact of the success of a connection to be displayed on the output unit 170. Thus, the user can surely recognize that application communication can be performed between the terminals A and B.

The new network forming process by the information processing terminal 100 according to the present embodiment has been described so far. When it is determined in steps S112 and S212 that the received time stamp is identical to its own time stamp, for example, a time stamp may be generated using a random number and then transmitted by a beacon, and then the processes of steps S112 and S212 may be executed once again. Through this process, a parent terminal can be reliably decided. Alternatively, it may be notified to the user as a network formation error, and the process may be executed once again from steps S100 and S200. Further, the user may select whether to cause the terminal to function as a parent terminal or a child terminal on an application of each terminal in advance. In this case, the determination processes of the parent terminal of steps S110 and S210 may not be performed.

<4. Process of Making Additional Connection to Network>

When a new information processing terminal 100 is added to an existing network as a child terminal, the process of any one of the terminals illustrated in FIG. 4 may be executed in the same way. In other words, the same gesture as the gesture input at the time of network formation is input in the information processing terminal 100 that desires to be additionally connected to the network (S100). At this time, a character string corresponding to the input gesture is generated, and an SSID and a password are generated as authentication information (S102 and S104). Then, the information processing terminal 100 searches for the presence of a parent terminal which is an access point to which the generated SSID is set (S106). At this time, when a parent terminal is searched, the information processing terminal 100 accesses the parent terminal as a child terminal, and makes a connection with the network (S108, S116, and S118).

However, when no parent terminal is present, it is determined as an additional connection error, and the user may be requested to input a gesture once again. Alternatively, the information processing terminal 100 may function as an access point of the generated SSID and form a new network.

<5. Process in Which Parent Terminal Leaves Network>

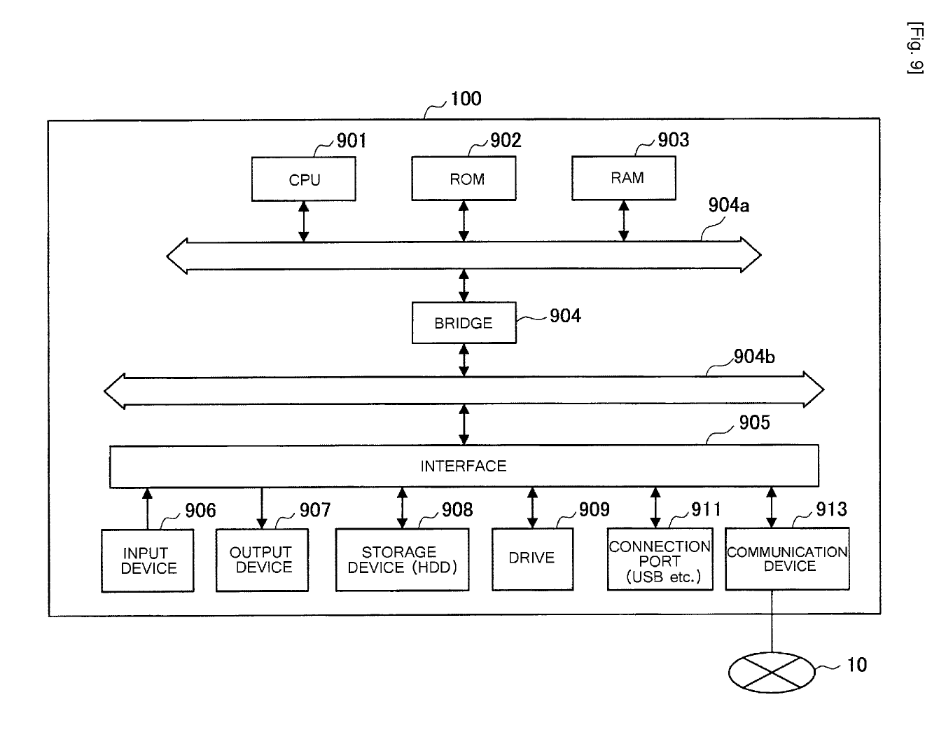

When the information processing terminal (the parent terminal) that functions as the access point of the formed network desires to leave the network, in the related art, the formed network needs to be disbanded once. On the other hand, in the present technology, when the parent terminal desires to leave the network, the function of the parent terminal may be transferred to the child terminal. Thus, the parent terminal can leave the network without disbanding the formed network. The process in which the information processing terminal 100 according to the present embodiment which functions as the parent terminal leaves the network will be described with reference to FIG. 8. FIG. 8 is a flowchart illustrating the process in which the parent terminal leaves the network according to the present embodiment.

In the example illustrated in FIG. 8, it is assumed that a network A1 is formed by the terminals A to C which are the information processing terminals 100. In the network A1, the terminal A functions as the parent terminal, and the terminals B and C function as the child terminals. Further, it is assumed that all of the terminals A to C include a program necessary to function as an access point.

When the terminal A functioning as the parent terminal desires to leave the network A1, first, the terminal A broadcasts an intention to leave the network A1 to the terminals B and C (S300). For example, the transmission of the intention to leave the network A1 is performed when the user of the terminal A inputs an operation to instruct network leaving through the input unit 110. The terminals B and C, functioning as the child terminals, which have received the intention to leave the network A1 from the terminal A transmit information about whether or not its own terminal can function as an access point and its own bandwidth used as performance information to the terminal A (S400 and S500).

The terminal A that has received the replies from the terminals B and C selects a terminal with a best bandwidth among terminals which can function as an access point as a new parent terminal based on the received information (S302). In step S302, the performance information is not limited to a bandwidth. For example, a terminal, which is determined as having a best function as an access point based on performance information of at least one of central processing unit (CPU) power of a terminal, the throughput information of a network, and the like, may be decided as a transfer destination terminal of an access point. In this case, in steps S400 and S500, the terminal A receives the corresponding performance information from the terminals B and C.

In the example illustrated in FIG. 8, it is assumed that the terminal B is selected as the new parent terminal. At this time, the terminal A instructs the terminal B to start preparation to function as an access point. The terminal B which is instructed to start preparation to function as an access point from the terminal A activates a program for functioning as an access point (S402) and notifies the terminal A of preparation completion when preparation is completed (S404).

The terminal A recognizes that the terminal B is ready to function as an access point through the notice from the terminal B in step S404, and then notifies the terminal B of the fact that the terminal A is to stop functioning as the access point (S304). Thereafter, the terminal A stops functioning as the access point and then leaves the network A1 (S306). The terminal B that has received the access point function stop notice from the terminal A starts functioning as an access point (S406). Thus, the terminal A leaves the network A1, and a network B1 including the terminals B and C is formed. The terminal C which is a child terminal can accesses the terminal B functioning as a new access point and perform data communication through the network A2 as it has been done so far.

The new network forming process, the process of making an additional connection with the network, and the process in which the parent terminal leaves the network by the information processing terminal 100 according to the present embodiment have been described above. As a result, the following effects are obtained.

First, by inputting a gesture through the information processing terminal 100, authentication information is generated, and a network with the information processing terminal 100 that has input the same gesture is formed. Thus, a very intuitive connection in which users who made the same operation are connected to each other can be implemented. At this time, when an operation necessary to connect the information processing terminals 100 to each other such as an operation to draw the same diagram is used as a part of an application or a part of the game application start, a concept to connect to a network can be concealed. Thus, the user does not consciously feel that the preparatory work to connect to a network is being performed, and so the user can purely enjoy an application. Since a connection with a network can be made by drawing a graphic, any user at any age can connect the information processing terminal 100 to a network.

Further, since a password is not shown to a user at all, a secure connection can be easily secured. Since it is unnecessary to directly input a password, a user having no information literacy can simply connect the information processing terminal 100 to a network.

In addition, since the information processing terminal 100 can be connected to a network by a simple operation on a screen, a network can be rapidly formed. Temporal fidelity or an operation of getting the information processing terminals 100 closer to each other to connect to a network are unnecessary, and the information processing terminal 100 can be simply additionally connected to an already formed network later. Further, since a communication path is generated in the process of connection operation, it is unnecessary to generate a communication path for prior authentication.

Further, after a network connection is released, authentication information of an SSID and a password used to form a network may be discarded as necessary. In this case, a one-time password can be securely issued or discarded.

Further, when the information processing terminal 100 functioning as the child terminal has the function of the access point, the right of functioning as the access point can be transferred from the parent terminal of the network to the information processing terminal 100. Thus, the function of the access point can be transferred from the parent terminal to the child terminal without disbanding a network once. Furthermore, since an SSID different from a normal DDIS is separately generated, a network connection can be made between the information processing terminals 100 even though a password unique to the user is not open to the public.

<6. Hardware Configuration Example>

The process by the information processing terminal 100 according to the present embodiment may be executed by hardware or software. In this case, the information processing terminal 100 may be configured as illustrated in FIG. 9. Next, a hardware configuration example of the information processing terminal 100 according to the present embodiment will be described with reference to FIG. 9.

The information processing terminal 100 according to the present embodiment may be implemented by a processing apparatus such as a computer as described above. The information processing terminal 100 includes a CPU (Central Processing Unit) 901, ROM (Read Only Memory) 902, RAM (Random Access Memory) 903, and a host bus 904a as illustrated in FIG. 9. The information processing terminal 100 further includes a bridge 904, an external bus 904b, an interface 905, an input device 906, an output device 907, a storage device (HDD) 908, a drive 909, and a connection port 911, and a communication device 913.

The CPU 901 functions as a calculation processing device and a control device and controls the entire operation of the information processing terminal 100 according to various programs. Further, the CPU 901 may be configured with a microprocessor. The ROM 902 stores a program, a calculation parameter and the like used by the CPU 901. The RAM 903 temporarily stores a program used in execution of the CPU 901, a parameter that appropriately varies in the execution, and the like. The components are connected with each other by the host bus 904a that includes, for example, a CPU bus.

The host bus 904a is connected with the external bus 904b such as a PCI (Peripheral Component Interconnect/Interface) bus via the bridge 904. The host bus 904a, the bridge 904, and the external bus 904b need not necessarily be constructed separately, and the functions may be implemented by a single bus.

The input device 906 includes an input section through which the user inputs information such as a mouse, a keyboard, a touch panel, a button, a microphone, a switch, and a lever and an input control circuit that generates an input signal based on the input from the user and outputs the input signal to the CPU 901. The output device 107 includes, for example, a display device such as a liquid crystal display (LCD) device, an organic light emitting diode (OLED) device, and a lamp or an audio output device such as a speaker.

The storage device 908 is an example of the storage unit of the information processing terminal 100 and is an apparatus for data storage. The storage device 908 may include a storage medium, a recording apparatus that records data in a storage medium, a reading apparatus that reads data from a storage medium, and a deletion apparatus that deletes data recorded in a storage medium. The storage device 908 includes, for example, a HDD (Hard Disk Drive). The storage device 908 drives a hard disk to store a program executed by the CPU 901 or a variety of data.

The drive 909 is a reader/writer for a storage medium and is installed inside or mounted to the information processing terminal 100. The drive 909 reads information recorded on a removable storage medium such as a mounted magnetic disk, an optical disc, a magnetic optical disc, or semiconductor memory and outputs the information to the RAM 903.

The connection port 911 is an interface connected with an external apparatus and is a port for a connection with an external apparatus that can transmit data through, for example, a USB (Universal Serial Bus). The communication device 913 is a communication interface that includes a communication device for connecting with a communication network 10. Further, the communication device 913 may include a communication device that supports a wireless LAN (Local Area Network), a communication device that supports a wireless USB, or a wire communication device that performs wire-line communications.

The exemplary embodiment of the present disclosure has been described hereinbefore with reference to the appended drawings, but the technical scope of the present disclosure is not limited to the above example. A person having ordinary skill in the art would understand that various modifications or variations can be made within the scope of the technical spirit defined in the claims and included within the technical scope of the present disclosure.

For example, in the above-described embodiment, the information generating unit 120 generates a character string from an input gesture based on the shape and the input order specified by the input gesture, but the present technology is not limited to this example. For example, the information generating unit 120 may generate a character string from an input gesture in terms of other features of an input gesture such as a color by which a gesture is drawn or an input place.

Further, the following configurations belong to the technical scope of the present disclosure.

(1) An apparatus including:

an input unit configured to receive an input gesture from a user;

an information generating unit configured to generate first information based on the input gesture;

a communication unit configured to

transmit the first information to another apparatus;

receive second information from the another apparatus; and

operate the apparatus as an access point of a network or to connect the apparatus to an access point created by the other apparatus based on the first information and the second information.

(2) The apparatus according to (1), wherein the first information and the second information each include a timestamp.

(3) The apparatus according to (2), wherein the communication unit operates the apparatus as the access point of the network if the timestamp in the first information is earlier than the timestamp of the second information and connects the apparatus to the access point created by the other apparatus if the timestamp of the second information is earlier than the timestamp of the first information.

(4) The apparatus according to (1) to (3), wherein the information generating unit recognizes characters based on the input gesture.

(5) The apparatus according to (4), wherein the information generating unit matches a text character string to each character recognized based on the input gesture.

(6) The apparatus according to (5), further comprising: a storage unit configured to store a plurality of text character strings each corresponding to a different character.

(7) The apparatus according to (5), wherein the information generating unit generates a service set identifier (SSID) and a password for the network based on the characters recognized.

(8) The apparatus according to (7), wherein the information generating unit generates the first information including the SSID, a password, and a timestamp indicating a time that the first information is transmitted to the another apparatus.

(9) The apparatus according to (1) to (8), wherein the communication unit transmits an intention to leave the network to each apparatus in the network, and in response receives an indication of a bandwidth of each terminal in the network.

(10) The apparatus according to (9), wherein the communication unit selects an apparatus in the network with a best bandwidth and notifies the apparatus in the network with the best bandwidth to take over as the access point of the network.

(11) The apparatus according to (1) to (9), wherein the apparatus includes a touch screen configured to receive the input gesture from a user.

(12) The apparatus according to (11), wherein the touch screen receives a plurality of shapes as the input gesture.

(13) The apparatus according to (1) to (10), wherein the apparatus is a portable telephone.

(14) The apparatus according to (13), wherein the portable telephone includes a touch screen configured to receive the input gesture from a user.

(15) The apparatus according to (14), wherein the touch screen receives a plurality of shapes as the input gesture.

(16) The apparatus according to (15), wherein the information generating unit retrieves a character string from an authentication information storage unit for each of the plurality of shapes and concatenates the character string for each of the plurality of shapes to form an authentication string.

(17) The apparatus according to (16), wherein the information generating unit divides the authentication string into two portions, a first portion being an SSID for the network and a second portion being a password for the network.

(18) A method including:

receiving an input gesture from a user;

generating first information based on the input gesture;

transmitting the first information to another apparatus;

receiving second information from the another apparatus; and

operating the apparatus as an access point of a network or connecting the apparatus to an access point created by the other apparatus based on the first information and the second information.

(19) A non-transitory computer readable medium encoded with a program that, when loaded on a processor, causes the processor to perform a method comprising:

receiving an input gesture from a user;

generating first information based on the input gesture;

transmitting the first information to another apparatus;

receiving second information from the another apparatus; and

operating the apparatus as an access point of a network or connecting the apparatus to an access point created by the other apparatus based on the first information and the second information.

(20) A system including:

a first apparatus including

an input unit configured to receive an input gesture from a first user;

an information generating unit configured to generate first information based on the input gesture;

a communication unit configured to transmit the first information to a second apparatus;

receive second information from the second apparatus; and

operate the first apparatus as an access point of a network or to connect the apparatus to an access point created by the second apparatus based on the first information and the second information; and

the second apparatus including

an input unit configured to receive the input gesture from a second user;

an information generating unit configured to generate second information based on the input gesture;

a communication unit configured to transmit the second information to the first apparatus;

receive the first information from the first apparatus; and

operate the apparatus as the access point of the network or to connect the second apparatus to the access point created by the first apparatus based on the first information and the second information.

### REFERENCE SIGNS LIST

100 Information processing terminal
110 Input unit
120 Information generating unit
130 Communication unit
140 Communication relation determining unit
150 Communication processing unit
160 Display processing unit
170 Output unit
180 Authentication information storage unit

1. An apparatus comprising:
an input unit configured to receive an input gesture from a user;
an information generating unit configured to generate first information based on the input gesture;
a communication unit configured to transmit the first information to another apparatus;
receive second information from the another apparatus; and
operate the apparatus as an access point of a network or to connect the apparatus to an access point created by the other apparatus based on the first information and the second information.

2. The apparatus according to claim 1, wherein the first information and the second information each include a timestamp.

3. The apparatus according to claim 2, wherein the communication unit operates the apparatus as the access point of the network if the timestamp in the first information is earlier than the timestamp of the second information and connects the apparatus to the access point created by the other apparatus if the timestamp of the second information is earlier than the timestamp of the first information.

4. The apparatus according to claim 1, wherein the information generating unit recognizes characters based on the input gesture.

5. The apparatus according to claim 4, wherein the information generating unit matches a text character string to each character recognized based on the input gesture.

6. The apparatus according to claim 5, further comprising:
a storage unit configured to store a plurality of text character strings each corresponding to a different character.

7. The apparatus according to claim 5, wherein the information generating unit generates a service set identifier (SSID) and a password for the network based on the characters recognized.

8. The apparatus according to claim 7, wherein the information generating unit generates the first information including the SSID, a password, and a timestamp indicating a time that the first information is transmitted to the another apparatus.

9. The apparatus according to claim 1, wherein the communication unit transmits an intention to leave the network to each apparatus in the network, and in response receives an indication of a bandwidth of each terminal in the network.

10. The apparatus according to claim 9, wherein the communication unit selects an apparatus in the network with a best bandwidth and notifies the apparatus in the network with the best bandwidth to take over as the access point of the network.

11. The apparatus according to claim 1, wherein the apparatus includes a touch screen configured to receive the input gesture from a user.

12. The apparatus according to claim 11, wherein the touch screen receives a plurality of shapes as the input gesture.

13. The apparatus according to claim 1, wherein the apparatus is a portable telephone.

14. The apparatus according to claim 13, wherein the portable telephone includes a touch screen configured to receive the input gesture from a user.

15. The apparatus according to claim 14, wherein the touch screen receives a plurality of shapes as the input gesture.

16. The apparatus according to claim 15, wherein the information generating unit retrieves a character string from an authentication information storage unit for each of the plurality of shapes and concatenates the character string for each of the plurality of shapes to form an authentication string.

17. The apparatus according to claim 16, wherein the information generating unit divides the authentication string into two portions, a first portion being an SSID for the network and a second portion being a password for the network.

18. A method comprising:
receiving an input gesture from a user;
generating first information based on the input gesture;
transmitting the first information to another apparatus;
receiving second information from the another apparatus; and
operating the apparatus as an access point of a network or connecting the apparatus to an access point created by the other apparatus based on the first information and the second information.

19. A non-transitory computer readable medium encoded with a program that, when loaded on a processor, causes the processor to perform a method comprising:
receiving an input gesture from a user;
generating first information based on the input gesture;
transmitting the first information to another apparatus;
receiving second information from the another apparatus; and
operating the apparatus as an access point of a network or connecting the apparatus to an access point created by the other apparatus based on the first information and the second information.

20. A system comprising:
a first apparatus including
an input unit configured to receive an input gesture from a first user;
an information generating unit configured to generate first information based on the input gesture;
a communication unit configured to transmit the first information to a second apparatus;
receive second information from the second apparatus; and
operate the first apparatus as an access point of a network or to connect the apparatus to an access point created by the second apparatus based on the first information and the second information; and
the second apparatus including
an input unit configured to receive the input gesture from a second user;
an information generating unit configured to generate second information based on the input gesture;
a communication unit configured to transmit the second information to the first apparatus;
receive the first information from the first apparatus; and
operate the apparatus as the access point of the network or to connect the second apparatus to the access point created by the first apparatus based on the first information and the second information.
